(19) United States
(12) Patent Application Publication
(10) Pub. No.: US 2008/0215411 A1
(43) Pub. Date: Sep. 4, 2008

(54) METHOD AND SYSTEM FOR PREDICTING RESOURCE REQUIREMENTS FOR SERVICE ENGAGEMENTS

(76) Inventors: Jianying HU, Bronx, NY (US); Bonnie Kathryn Ray, Nyack, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 12/062,959

(22) Filed: Apr. 4, 2008

Related U.S. Application Data
(63) Continuation of application No. 11/247,197, filed on Oct. 12, 2005.

(51) Int. Cl. G06Q 10/00

(52) U.S. Cl. 705/8

(57) ABSTRACT

A method and system for predicting resource requirements of a current service engagement by modeling records of past service engagements to create and classify templates of service resource usage. This is done by clustering past engagements into groups having similar time series requirements for service resources. A service resource template for the current service engagement is generated from a classified template by using characteristics of the current service engagement to select a group of which the current service engagement is a likely member. The corresponding template is then customized to fit the characteristics of the current service engagement. The invention may be implemented using Hidden Markov Models. An aspect of the invention is use of dynamic time warping to quantify dissimilarity between engagement sequences prior to fitting Hidden Markov Models. Another aspect of the invention is removal of outliers from the clustered groups.

### BACKGROUND OF THE INVENTION

1. Field of the Invention

The present invention generally relates to methods of predicting resource requirements, and in particular to processes for predicting resource requirements for services engagements.

2. Background Description

The global economy is increasingly driven by services related exchanges, often in the form of services engagements. A service engagement is an activity where one company provides a particular type of service (software implementation, business transformation consulting, etc.) to another company for an agreed-upon amount of time to achieve a specified business objective at an agreed-upon price. The duration of a service engagement may vary from weeks to years. Each service engagement typically requires many different types of human resources (software architect, project manager, SAP specialist, etc.), and the requirement may vary at different points of time during the engagement.

Once a service engagement contract is signed, the provider company needs to quickly assemble the required resources to carry out the project. At any given time, a large company typically will have multiple active service engagements at different stages of completion, thus demand management and resource supply are significant drivers of profitability for services engagements.

However current tools and methodologies do not provide sufficient forecasting capabilities to efficiently and effectively manage supply and demand. One current tool applies time-series extrapolation to historical records of resource requirements at aggregate level to provide predictions of future demand. However this tool cannot be applied directly at engagement level because it doesn't provide any means to compare and categorize individual engagements.

Another tool performs skill matching to find the best set of candidates for a given set of skill requirements, however this requires that the resource requirements are already known. To summarize, no one has come up with a method to predict resource requirements at the engagement level.

### SUMMARY OF THE INVENTION

It is therefore an object of the current invention to provide a method and system to predict resource requirements of service engagements at the engagement level.

A further object of the invention is to provide service requirement predictions that can be used by project and resource managers for developing project plans and resource requirements in an efficient and standardized way.

It is also an object of the invention to provide service requirement predictions that can be used to guide pricing during contract negotiation.

According to the present invention, resource requirement prediction is carried out in two different operations. In the first operation, called “modeling operation”, records of past engagements are analyzed in three stages. In the first stage, a mathematical method is applied to cluster the engagements into one or more groups such that all engagements in the same group have similar resource requirements. In the second stage, another mathematical method is applied to each group of engagements to create a staffing template reflecting in detail typical resource requirements for this type of engagements. In the third stage, a type characterization is generated for each group by which further engagements can be identified as belonging to one of the clustered groups.

In the second operation, called “prediction operation”, characteristics of a new service engagement are input into the system. The system then assigns this engagement to one of the pre-computed groups and retrieves the corresponding templates. Adjustments are then made based on all known attributes of the engagement such as estimated revenue and duration to generate the final template tailored for this specific engagement.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow chart showing the steps of the modeling operation.

FIG. 2 is a flow chart showing the steps of the prediction operation.

FIGS. 3A, 3B, 3C and 3D are time series graphs showing service resource usage in past engagements.

FIG. 4 is a time series graph predicting service resource usage for a new engagement.

### DETAILED DESCRIPTION OF A PREFERRED EMBODIMENT OF THE INVENTION

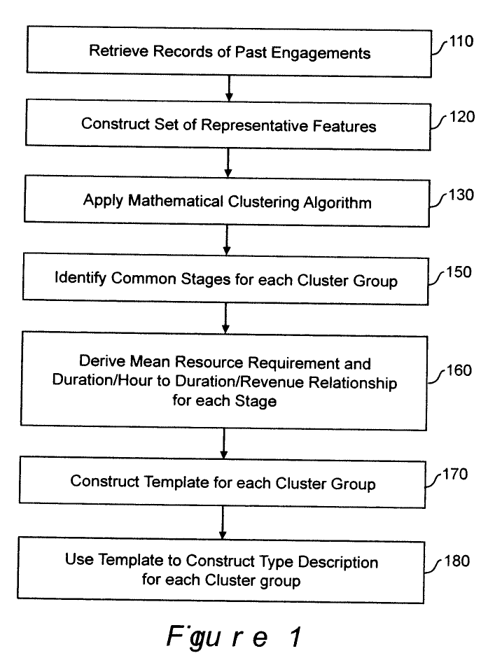

Referring now to the drawings, and more particularly to FIG. 1, there is shown a flow chart for the modeling operation. Step 110 is to retrieve records of past engagements. Each record contains some measure of resource requirement (e.g., hours claimed) for at least one of the resources for at least one of the recording period (day, week, month, year) for each engagement. In step 120 there is constructed, for each engagement and at each period with recorded resource requirements, a set of features representing the resource requirements. The feature set may include, but is not limited to, the resource type distribution during each period.

In step 130 a mathematical algorithm is applied to cluster the engagements into groups such that engagements in each group have similar resource requirements as measured by the set of features constructed in step 120 throughout the whole duration of the project. Possible mathematical algorithms may include:

1) Compute the dissimilarity between any two engagements based on the temporal average of the features, then apply hierarchical clustering as described in A. K. Jain and R. C. Dubes, Algorithms for Clustering Data, Prentice Hall, N.J., 1988.

2) Compute the dissimilarity between two engagements based on the temporal mapping computed using Dynamic Time Warping (DTW) (as described in L. R. Rabiner and B. H. Juang, Fundamentals of Speech Recognition, Prentice Hall, N.J., 1993) then apply hierarchical clustering.

3) Fit mathematical models (i.e., Hidden Markov Models) to the set of engagements and cluster the engagements using these fitted models.

In step 150, we fit a mathematical model to each group of engagements derived from step 140 to identify the common stage(s) for this group of engagements and segment each engagement into these stages. In step 160, for each common stage of each engagement group, we apply a mathematical model to derive 1) the mean resource requirement feature for this stage, and 2) the relationship between the duration and hour requirement of this stage and the total duration and revenue of the whole engagement. In step 170 we construct a template for each group of engagements using the analysis results from step 160. In step 180, based on the templates, we construct verbal descriptions for each group of engagements characterizing its type (e.g., package implementation, transformation and planning, etc.)

Note that the foregoing “modeling operation” may be repeated periodically so that the staffing templates can adapt to evolving requirements of existing types of engagements as well as new types of engagements.

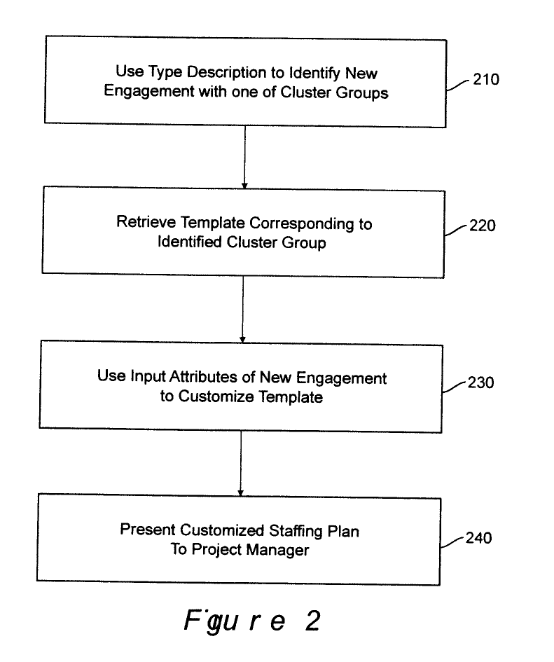

The detailed steps of the “prediction operation” may be understood with reference to FIG. 2. In step 210 the partner/project manager classifies the engagement into one of the pre-clustered groups based on the verbal descriptions generated in step 180 of the “modeling operation”. In step 220 the system retrieves the template corresponding to the identified group. In step 230 the system customizes the template based on input attributes of the engagement, such as estimated revenue and total duration, using formula derived from step 160 of the “modeling operation”. In step 240 the system presents the partner/project manager with the customized staffing plan.

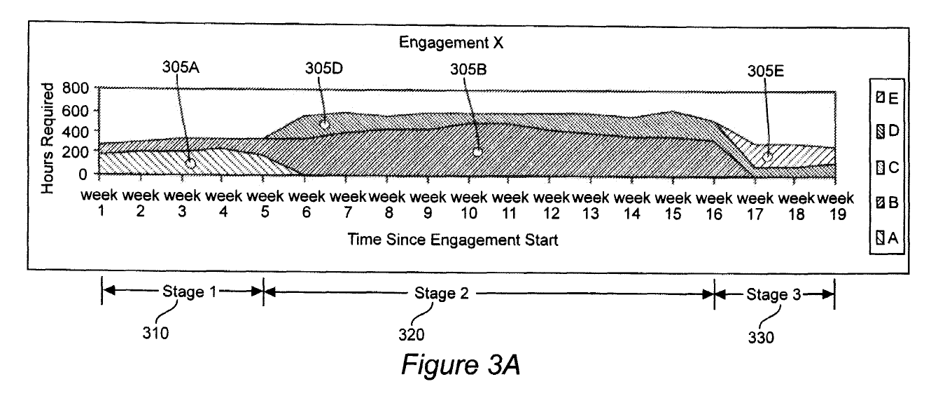

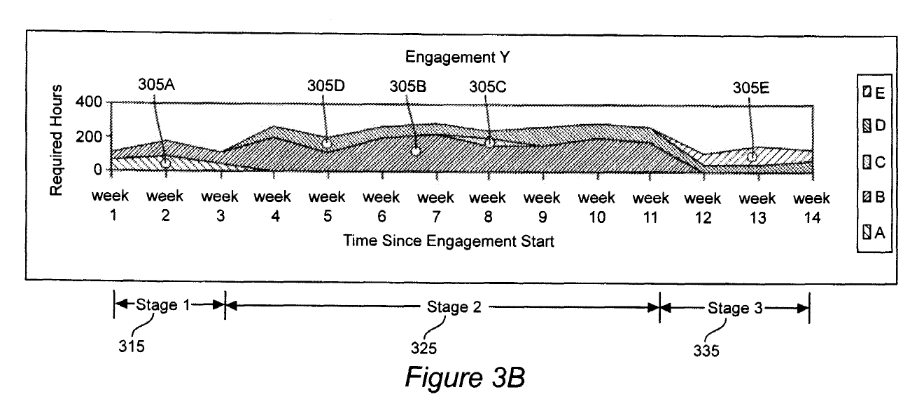

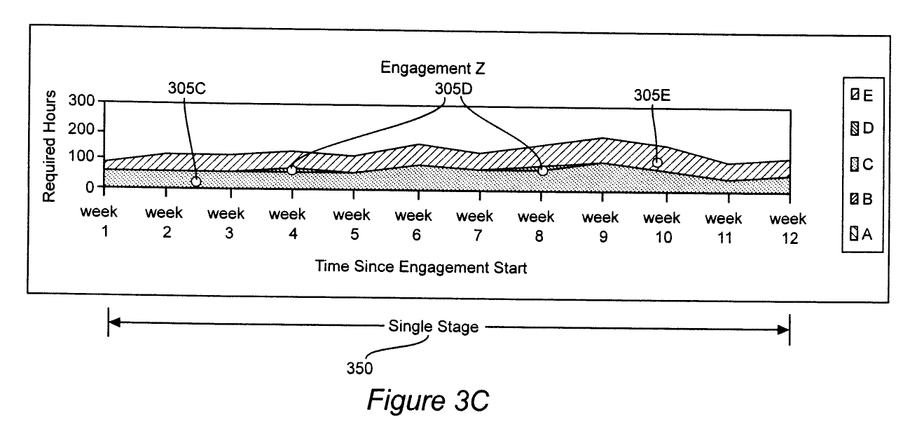

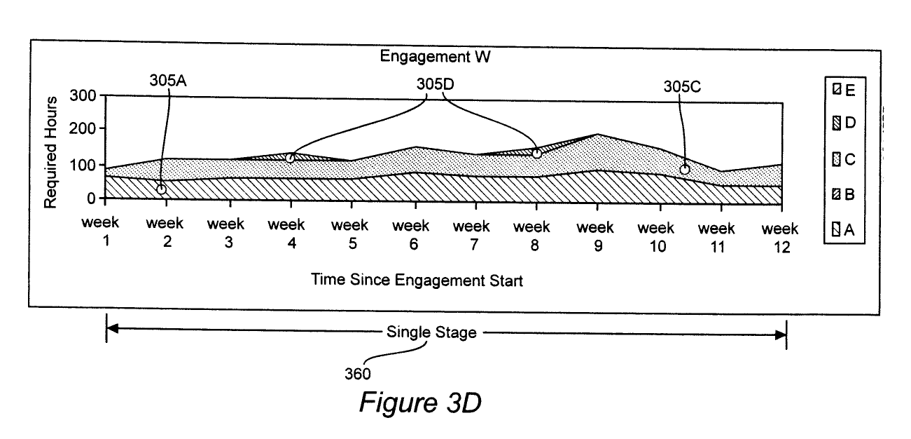

The foregoing methodology may be illustrated with reference to the following examples shown in FIGS. 3A, 3B, 3C and 3D. A company ServCo provides services involving 5 types of resources labeled A (305A), B (305B), C (305C), D (305D), and E (305E) (e.g. A could be Java Programmer, B could be Application Architect, etc.). We have historical records of 500 of their past engagements. Records of four of these engagements, X, Y, Z and W are shown in FIGS. 3A, 3B, 3C and 3D, respectively, as examples. Each of these figures is a plot of hours required of each resource type for each week throughout the engagement.

As seen from these figures, although engagements X (shown in FIG. 3A) and Y (shown in FIG. 3B) have very different total hour requirements and duration, they are similar in that they each seem to have three distinct stages, and the resource requirement for the corresponding stages of the two engagements are similar in terms of the distribution among the 5 resource types. On the other hand, engagement Z (shown in FIG. 3C) and W (shown in FIG. 3D) each has only one stage (350, 360), with resource distributions that are very different from each other or what's seen in engagement X (shown in FIG. 3A) and engagement Y (shown in FIG. 3B).

This illustrates a common property of service engagements in a typical organization: they are of varying length, varying duration and varying sizes. However, they often contain “clusters” where within each cluster the engagements are similar to each other in terms of stages involved and the resource distribution for each stage. These clusters represent different types of engagements. By identifying these types and developing different models and templates for each distinct type of engagement, we can more accurately predict the resource requirements of a new engagement.

In this example, using an HMM clustering algorithm (as described under the subheading “Clustering Analysis” below) we can identify three clusters of sizes 200, 100, 200, each representing a distinct engagement type. The first cluster (including engagements X and Y) consists of engagements with three stages, the latter two both consist of single-stage engagements. We then fit an HMM to each cluster to segment the series of weekly hours claimed into different stages (e.g., weeks 1-5 of engagement X and weeks 1-3 of engagement Y are all in stage 1 (310, 315) of the first cluster). (Note: in the single-stage clusters no more segmentation is needed.) For each stage, the mean distribution and the mean duration as a ratio of the total engagement length is then calculated. For example, for the first stage of the first cluster, the detailed data (not shown) indicate that the mean distribution is: A: 63%, B: 37%, C: 0%, D: 0%, E: 0%, and the mean duration is 27% of total engagement length. Further more, based on the revenue of each engagement, the mapping factor between the total revenue and total hours required for each stage is computed. One possible way to compute this mapping is using linear regression to estimate the expected number of hours for Stage 1 as a function of the proportionate revenue for Stage 1, using Stage 1 (310, 315) data for all projects in Cluster 1. One possible way to obtain the proportionate revenue for each stage is to compute it as the total revenue times the length of the stage relative to the total length. These parameters combined make up the “template” for each type of engagements. A similar procedure could be used for Stage 2 (320, 325) and State 3 (330, 335).

As an example, the complete template for cluster 1 (FIGS. 3A and 3B) include:

1. Distributions of the 5 resource types for the three stages:

[67%, 33%, 0%, 0%, 0%], [0%, 68%, 0% 32%, 0%] and [0%, 0%, 0%, 40%, 60%]

2. Mean duration for each stage as percent of total length: [27%, 53%, 20%].

3. Revenue to hours mapping factor for each stage: [0.0028, 0.0052, 0.0023].

Each template is then reviewed by domain experts to generate verbal descriptions for the corresponding type of engagements. For example, the first cluster is labeled “Business Transformation” while the second one is labeled “Package Implementation”, etc.

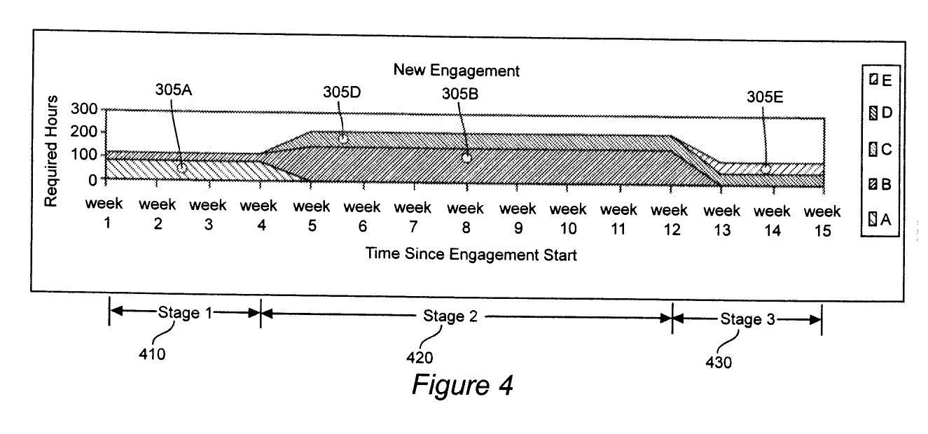

When a new engagement comes in with estimated revenue and total duration, the staffing manager first classifies it as belonging to one of the identified engagement types. The template corresponding to that engagement type is then retrieved and used to generate a detailed staffing requirement estimate. For example, the staffing requirement estimate for a new engagement classified as type “Business Transformation” with an estimated duration of 15 weeks and estimated revenue of $640,000 is shown in FIG. 4.

To be more specific, based on the total estimated length of 15 weeks and the mean durations in the template, the estimated lengths for the three stages (410, 420 and 430) are [4, 8, 3]. Breaking up the total revenue of $640,000 in proportion to the durations, the proportionate revenues for the three stages are: [$172,800, $339,200, $128,000]. Multiply the revenue for each stage by the corresponding revenue-to-stage mapping factor results in the total hours for the three stages: [484, 1764, 294].

Dividing the total hour of each stage by the length of the stage gives us the weekly hours for the three stages: [121, 220, 98]. Finally, multiplying the weekly hours by the resource type distribution for the stage the week is gives the mean weekly resource demands for each of the three stages (as displayed in FIG. 4):

Stage 1 (410): [81, 41, 0, 0, 0]

Stage 2 (420): [0, 150, 0, 70, 0]

Stage 3 (430): [0, 0, 0, 39, 59]

### Clustering Analysis

Clustering analysis is a way to derive structure from data by automatically partitioning the data into homogeneous groups. Model based clustering uses mathematical models to represent clusters and attempts to optimize the fit between the models and the data. The novel approach described below provides for model based sequence clustering. The approach is based on Hidden Markov Models (HMM) with interlocking steps of model selection, estimation and sample grouping, using a combination of Bayesian methodology and hierarchical clustering with Dynamic Time Warping (DTW). We will demonstrate with experimental results that the algorithm can effectively handle sequences of variable lengths, unbalanced clusters as well as presence of outliers.

1. Introduction

Model based clustering has been widely used in many applications especially those involving complex data. Compared to distance based clustering, model based methods provide better interpretability and richer representation of the data. Some useful models involved in model based clustering include Gaussian Mixture models, multinomial models, Markov models and Hidden Markov Models (HMMs).

HMM is an extension of the Markov model in that the states can not be observed directly and the observation is a probabilistic function of the states. HMMs are particularly attractive for the clustering of time series, or more generally, sequence data, for two reasons. First, they represent a formal probabilistic model with solid mathematical foundations and there exist efficient and well-defined algorithms for inducing HMMs from a set of sequences. Second, the hidden states in HMMs provide a compact and easy to interpret representation of the underlying “stages” in a dynamic process. Even though the exact sequence of states behind each generative process can not be observed, it can be estimated by studying the observable output of the system. Because of these desirable properties, HMMs have been successfully used to model a wide variety of real-world time series for applications including speech recognition, protein sequencing, computational molecular biology, handwriting recognition and human gesture recognition.

However, while well known algorithms exist to induce HMMs from a set of time series, these algorithms do not directly address the problems of clustering the time series: they simply attempt to fit a single model that best accounts for all of the data, regardless of whether it was generated by one or multiple underlying processes. Clustering time series data using HMMs is a very different and much more complex task: it involves the difficult tasks of estimating the number of regimes, or underlying processes, as well as the number of states hidden in each regime.

Early work on HMM based sequence clustering focused on speech recognition and assumed that the number of states in the models is known before clustering (e.g., pre-defined by linguistic experts). Also, clustering results in most of these systems are evaluated and selected based on the amount of improvement in recognition accuracy achieved by the models. Some more rigorous methods for cluster number selection were later proposed by Smyth (P. Smyth, “Clustering sequences with hidden Markov models”, in M. Mozer, M. Jordan, and T. Petsche, editors, Advances in Neural Information Processing, MIT Press, 1997), who used Monte-Carlo cross validation, and Oates et al. (T. Oates, L. Firoiu, and P. Cohen, “Using dynamic time warping to bootstrap hmm-based clustering of time series”, in R. Sun and C. L. Giles, editors, Sequence Learning, Springer-Verlag, 2000), who used an initialization process based on Dynamic Time Warping and hierarchical clustering. However both systems still assume that the number of states is known beforehand and fixed for all clusters.

More recently, Cen Li et al. (C. Li, G. Biswas, M. Dale, and Pat Dale, “Matryoshka: A hmm based temporal data clustering methology for modeling system dynamics”, Intelligent Data Analysis, pages 281-308, June 2002) proposed a more general clustering methodology called Matryoshka, which does not assume that the number of states in the HMMs are known beforehand or fixed for all clusters. The method is a top down approach which starts by assigning all sequences to one cluster fitted by a single state model, then iteratively increase the number of states as well as the number of clusters. Both the partition size (number of clusters) and model sizes (number of states) are determined using a Bayesian Information Criteria (BIC) based measure. The BIC measure is deployed to ensure that the HMMs generated are accurate representations of data, and at the same time are meaningful abstracts that are easy to interpret, e.g., not overtly complex.

While Matryoshka demonstrates a more general framework which allows the objective, data driven determination of both model and partition sizes in HMM based sequence clustering, there are several drawbacks in the methodology which hinders its application in many real-world situations. First, the method assumes that all sequences are of equal length. Second, to generate new clusters, the method uses a simple approach of initializing a new cluster using the sequence that is farthest from the existing models. Since the expectation-minimization (EM) style iterative procedure used to refine the models at each stage is highly sensitive to the initial condition, this simple approach makes the method unstable when the data contains unbalanced clusters (clusters of very difference sizes), or outliers (singletons or very small clusters). Finally, the method provides no mechanism to handle outliers or noise in the data: it attempts to account for all the data with HMMs. Because of the latter two factors, Matryoshka tends to get “distracted” in the presence of highly unbalanced clusters or outliers and results in sub-optimal models.

Therefore, a new algorithm for HMM based sequence clustering designed to address these problems is necessary. The algorithm described below adopts a top-down iterative approach, but differs from Matryoshka in three important aspects. First, a normalized BIC measure is adopted to allow for sequences of varying lengths. Second, a mechanism called outlier pool is introduced to dynamically identify and handle outliers throughout the clustering process. Finally, we have developed a more sophisticated methodology for creating and initializing new clusters. Whenever the partition size is to be increased, the candidate cluster for splitting is identified based on a fitness evaluation of all existing models. Then, Dynamic Time Warping (DTW) combined with hierarchical clustering is used to initialize the two new clusters. Experimental results demonstrate that this new methodology combined with the outlier pool effectively improves the robustness of the clustering results.

DTW was also used by Oates et al. in sequence-based clustering. However, in their system DTW was applied once to identify all clusters, which were then adjusted and refined using HMMs with known number of states. In contrast, in our method, DTW is interleaved into every step of a top-town, model-based clustering scheme which searches for the optimal number of clusters and optimal number of states for each cluster in an iterative manner guided by a normalized BIC measure.

2 Background

In this section we provide a basic introduction to two important tools for sequence analysis that are deployed in our system: Hidden Markov Models and Dynamic Time Warping.

2.1 Fundamentals of Hidden Markov Models

A discrete HMM is defined by the following 5 items:
a set of states {1, 2, . . . , N}.
an alphabet of M symbols {σ₁, σ₂, . . . , σ_{M}}
a set of state transition probabilities

aᵢⱼ=P (sₜ₊₁=j|sₜ=i), 1≦i, j≦N, where sₜ denotes the state at time t
a set of state emission probabilities: bᵢⱼ=P (oₜ|σⱼ|sₜ=i), 1≦i≦N, 1≦j≦M, where oₜ denotes the symbol observed at time t
an initial state probability distribution: pᵢ=P(s₁=i), 1≦i≦N.

A continuous distribution HMM is one where the emissions are continuous variables governed by a probability density function (i.e. the normal density) instead of a discrete distribution.

A left-to-right HMM is one that satisfies the conditions: aᵢⱼ=0 if j>i+1 or j<i; and p₁=1. In other words, it is an HMM with a fixed initial state and constrained topology where the states are ordered and there are only two possible transitions at each state: stay in the same state, or move to the next one.

Let λ be an HMM, and X={x₁, x₂, . . . , x_{K}} be a set of sequences, there exist efficient dynamic programming algorithms to solve the following three problems:
For each xᵢ find the sequence of states, q, that maximizes the probability P(xᵢ|λ,q): the Viterbi algorithm.
Determine the probability of observing each sequence xᵢ given that it was generated by λ: the forward algorithm.
Determine the parameters of λ that maximize the likelihood of X: the Baum-Welch algorithm or the Segmental K-means algorithm.

We have chosen to use discrete left-to-right Hidden Markov Models estimated using segmental K-means training to implement and evaluate our clustering algorithm for simplicity and the fact that this type of models has proven to be particularly suitable for many real world applications. It should be noted, however, that this is not a fundamental choice: the algorithm and the analysis given here apply to more general HMMs and different choices of HMM training techniques as well.

2.2 Dynamic Time Warping

While HMM offers a powerful tool for modeling time series, it does not provide a convenient way to directly compare two sequences. In unsupervised clustering, there are often situations when there is a need to quantify the dissimilarity/distance between any two given sequences before model estimation. Finding such a measure is difficult because even two sequences generated by the same model may appear very different in that they may have very different lengths, and the underlying stages may progress very differently in the two sequences in a non-linear manner.

DTW is a dynamic programming algorithm designed to solve this problem. It efficiently searches for the optimal mapping between the points in the two sequences that minimizes the accumulated point-wise distance and then returns this distance as the dissimilarity measure between the tow sequences. In our algorithm DTW is used to provide initializations for newly generated clusters in a manner that is robust to the presence of outliers.

3 The Clustering Algorithm

Suppose we have a set of N sequences (samples) of varying lengths: X=(x₁, . . . , x_{N}). We assume that a majority or all of the data was generated by an unknown number of HMMs of unknown sizes, each representing a “dominant” underlying regime in the data. By “dominant” we mean it represents a significant number of sequences. However, the number of sequences represented by each dominant regime may vary widely (i.e., the corresponding clusters maybe highly unbalanced). We further assume that the data may contain outliers, i.e., sequences that do not belong to any of the dominant regimes. The goal of the clustering algorithm is to identify the clusters that correspond to these dominant regimes along with the underlying models.

This clustering problem can be viewed in a Bayesian framework, where given a set of data and assuming that it comes from a mixture of models, we attempt to find the best estimate of the model parameters such that they lead to maximum likelihood of the data. The challenge is how to solve the nested problems of identifying the “right” number of clusters, and given a cluster, the “right” model size for the cluster.

We adopt the top down approach where we start with the minimal size for both model and partition, and increment them in an estimation-maximization (EM) like procedure until a certain “goodness” measure is reached. A Bayesian Information Criterion (BIC) based measure is adopted as this goodness measure.

Tables 1-3, below, give the outline of our clustering algorithm. In the following sections we explain in detail the three key components of this algorithm: model and partition size selection, partition growing strategy, and outlier handling.

3.1 Normalized BIC for Model and Partition Size Selection

Bayesian Information Criterion (BIC) was first proposed as a criterion for mixture model selection in a Bayesian framework. It was derived from an asymptotic approximation formula proposed by Schwarz in 1978. The basic definition of the BIC measure given a mixture model M and data set X is:

$$B I C ( M , X ) = log P ( X \vert M , \hat{θ} ) - \frac{d}{2} log N , \qquad ( 1 )$$

where \hat{θ} is the maximum likelihood estimate of the model parameters, d is the number of free parameters in the model, and N is the number of data samples in X. The first term in the formula is the likelihood term which tends to favor larger and more detailed models, while the second term is the model complexity penalty term which favors simpler models. Thus BIC has the effect of selecting the best model for the data by trading off these two terms. Over the years, various forms of the BIC measure has been used successfully in many different applications, however most of these applications involve clustering of static data points as opposed to sequences.

Cen Li et al. adopted the BIC measure for sequence clustering and demonstrated that it can be effectively used to determine both model sizes and partition size in that context as well. However they used a straightforward formulation where likelihoods of sequences are placed directly in the likelihood term of the BIC measure.

While this straightforward adaptation appeared to work well for sequences of fixed length, it proved to be problematic when the sequences are of widely varying lengths. Because of its cumulative nature, the likelihood of a sequence tends to be lower for longer sequences. Thus BIC measures using un-normalized sequence likelihoods are biased towards longer sequences.

To correct for this bias, we normalize the sequence likelihood by the length of the sequence in the first term, and to balance it added a regularization factor α (roughly the reverse of the average sequence length) to the penalty term, resulting in what we call normalized BIC measures.

For model λₖ with parameters \hat{θ}ₖ estimated from cluster Xₖ, the model BIC measure is defined as:

$$B I C ( {X}_{k} , {λ}_{k} ) = {\sum }_{j = 1}^{{N}_{k}} \frac{log P ( {χ}_{i} \vert {λ}_{k} , {\hat{θ}}_{k} )}{\vert {χ}_{kj} \vert} - α \times \frac{{d}_{k}}{2} log {N}_{k} , \qquad ( 2 )$$

where χₖⱼ is the jth sequence in cluster Xₖ, |χₖⱼ| is its length, and P(χₖⱼ|λₖ,\hat{θ}ₖ) is the likelihood of the sequence.

Similarly, for a given partition M with K clusters, the partition BIC measure is defined as:

$$B I C ( X , M ) = {\sum }_{i = 1}^{N} {\sum }_{k = 1}^{K} {P}_{ik} \frac{log P ( {χ}_{i} \vert {λ}_{k} , {\hat{θ}}_{k} )}{\vert {χ}_{i} \vert} - α \times \frac{K + {\sum }_{k = 1}^{K} {d}_{k}}{2} log {N}_{k} , \qquad ( 3 )$$

where Pᵢₖ is 1 if sample χᵢ is in cluster k and 0 otherwise.

The process of model size selection is embedded in the Model Construction module referred to in Table 1. The module starts from having only one state and keeps increasing the number of states. For each given number of states it fits an HMM model using the segmental K-means algorithm and then computes the model BIC measure using equation 2. When this measure begins to decrease, it selects the number just before it as the number of states.

Similarly, to choose the number of clusters, the algorithm starts from one cluster and keeps increasing the number of clusters until the partition BIC measure computed by equation 3 begins to decrease (as shown in Table 1).

3.2 Outlier Handling

Outliers in the context of model based clustering refer to objects that do not belong to any of the dominant underlying regimes. Most likely these objects have been generated due to system anomaly or noise and therefore are not of primary interest.

Outliers are very common in real world data and can cause serious difficulty in model based clustering. First, mixing outliers in a “legitimate” cluster leads to the “contamination” of the model. Second, even if the algorithm is capable of isolating the outliers, they lead to a diversion of the model parameter resource. Thus very often, when there are outliers, a model based clustering algorithm that attempts to account for all data with models will only identify the outliers at the expense of failing to isolate some of the dominant regimes.

To resolve this problem, we have designed a mechanism called outlier pool to manage outliers in our algorithm, as shown in the Sample Reassignment/Outlier Detection module in Table 3. Instead of attempting to account for all sequences with HMM models, we allow each model to reject a sequence whose likelihood is too low. A sequence that is rejected by all current models is placed in the outlier pool. The outlier pool is a special “garbage” cluster which is not modeled. To be more specific, no model is estimated from the outlier pool, and members of the outlier pool do not enter into the BIC measures. Note that this outlier pool is dynamic: objects can enter into or exit from the outlier pool as the clustering algorithm proceeds.

The threshold used to determine whether a sequence should be accepted or rejected by a model is selected based on the expected likelihood of each model, estimated using Monte Carlo simulation. For each model, 500 sequences are generated according to the model parameters. Then the normalized likelihood of each sequence against the given model is computed and the average is taken as the expected likelihood of the model.

3.3 Partition growing using DTW

As shown in Table 1, the algorithm starts with one cluster and then incrementally grows the number of clusters until the partition BIC measure reaches a maximum point. For each given number of clusters, the initial set of clusters and models are adjusted using an EM procedure as outlined in Table 3, Sample Reassigrunent/Outlier Detection. Since the EM algorithm will only converge to a local optimal point, its outcome greatly depends on the initial partition. Thus a crucial step in a top-town model based clustering algorithm is the initialization of a new cluster from an existing set of clusters.

One possible strategy is to seed the new cluster with the data sample that is “least fit”, i.e., farthest away from all current models (e.g., the method adopted in Cen Li et al.). While this works reasonably well for clean data, it is sensitive to outliers. When there are outliers in the data, the data sample that is farthest away from all models is very likely an outlier. Thus using this strategy the cluster growing process tends to be dominated by outliers.

We have adopted a more robust alternative. Instead of evaluating each individual sequence for fitness, each cluster is evaluated as a whole. The cluster with the lowest average likelihood is identified as the candidate for splitting. The assumption is that the cluster with the lowest likelihood is most likely to be a composite cluster whose model is an average of the true underlying models.

The identified cluster is then split into two new clusters based on distance measures computed using DTW. To be more specific, DTW is first applied to each pair of sequences in the original cluster to generate a pair-wise distance matrix. Hierarchical clustering is then applied to group all sequences in the original cluster into to two new clusters.

4. Experiments

Synthesized data were generated to systematically evaluate our algorithm and compare it against one of the previous methods.

4.1 Data Description

To generate a synthesized data set, first the number of regimes and the sizes of the clusters corresponding to these regimes are determined. Then the underlying HMM for each regime is created and the desired number of sequences generated. Singleton clusters or clusters with a small number of samples are used to simulate outliers.

Clearly the level of difficulty in clustering a synthesized data set depends on the pair-wise distances between the generating HMMs. A number of distance measures have been developed to compare different HMMs and we have adopted a slightly modified version of the symmetrized similarity measure (SSM) proposed by Juang and Rabiner (B. Juang and L. Rabiner, “A probabilistic distance measure for hidden Markov models”, AT&T Technical Journal, 64(2):391-408, February 1985). Given two HMM's λ₁ and λ₂, the SSM between these two models is defined as:

$$D ( {λ}_{1} , {λ}_{2} ) = \frac{( L ( {O}_{2} \vert {λ}_{1} ) - L ( {O}_{1} \vert {λ}_{1} ) ) + ( L ( {O}_{1} \vert {λ}_{2} ) - L ( {O}_{2} \vert {λ}_{2} )}{2} , \qquad ( 4 )$$

where Oᵢ is a set of observation sequences generated by model λᵢ and L(Oᵢ|λⱼ) is the average normalized log-likelihood of sequences in Oᵢ given model λⱼ. It is essentially a measure of how well each model matches data generated by the other model compared to data generated by itself, and is always negative, with a larger number indicating more similar models.

The HMMs used to generate our synthesized data are discrete, left to right models as specified in section 2.1. Each model has two or three states. To generate different emission probability distributions, we first generated 6 normal distributions with deviation of 0.5 and means of i*2.0, 1≦i≦6. We then calculated the probabilities for each 1.0 interval between 0.5 and 12.5 for each distribution, arriving at six distinct discrete probability distributions for thirteen symbols. The emission probability distributions for all generating HMMs are selected from these six distributions. The distance between any two HMMs is controlled by the number of states that that have shared emission probabilities and the self-transition probabilities of these states.

Instead of using a fixed length for all sequences as in previous methods, we allow the length of the sequences to vary to more closely simulate the situation in most applications. Since the HMMs are left-to-right models with a forced initial and final state, the expected sequence length for each model is essentially determined by the self-transition probabilities for the states. We adjusted these transition probabilities such that all models have an expected sequence length of 50, and allowed individual sequence length to vary between 30 and 100.

Two synthetic data sets were used in our evaluations, generated using ten HMMs. Models 1 to 5 (referred to as major models) were used to generate dominant regimes and models 6 to 10 (referred to as noise models) were used to simulate outliers. The expected normalized log-likelihood for each model is in the range [−1.1, −0.8]. Each pair of HMMs has 0 to 2 shared states, and the SSM measure ranges from −2.1 for models that are very close to each other, to −5.8 for models that are more far apart. For both data sets the sizes for the major clusters are 100, 60, 30, 30, 10 respectively. For outliers, the first data set has 5 singletons while the second one has 5 minor clusters with sizes 4, 3, 2, 1, 1.

4.2 Performance Measures

Two performance measures are used to quantitatively measure the performance of our clustering algorithm. The first is the Partition Misclassification Count (PMC) proposed by Cen Li et al. This measure is a weighted sum of all different types of object misclassifications that occur in the derived partition. The smaller the count, the closer the derived partition is to the true partition and thus more accurate the clustering algorithm. While this measure can provide a good comparison between two different algorithms, it is somewhat difficult to interpret as an indicator of how well an algorithm does.

We thus propose another performance measure called Difference of Concordance Matrix (DCM). Given a set of N objects, the concordance matrix C is a 0-1 N×N matrix where cᵢⱼ=1 if ith object and jth object are in the same cluster and cᵢⱼ>0 otherwise. DCM measure is then defined as:

$$D C M = \frac{{e}^{T} ( \vert {C}_{t} - {C}_{d} \vert ) e}{{e}^{T} {C}_{t} e} \qquad ( 5 )$$

where e is vector of ones, Cₜ and C_{d} are concordance matrixes for the true partition and derived partition respectively and || is the component wise absolute value of a matrix. e^{T}Ce thus computes the sum of all components in matrix C.

DCM measure is a measure of the mismatch between the true partition and derived partition. Its value ranges from 0 to 1 with 0 indicating a perfect match and 1 indicating a complete mismatch.

4.3 Experimental Results

Our clustering algorithm was evaluated using the two synthetic data sets described in section 4.1. For comparison, we also implemented the Matryoshka algorithm developed by Cen Li et al. and evaluated it on the same data sets.

Table 4 gives the performance measures of both algorithms, with results of our algorithm listed under “Proposed”. As can be seen from the table, our algorithm significantly outperforms the Matryoshka algorithm in both measures for both data sets.

For a more detailed comparison, the cluster compositions derived from both algorithms on data set 1 are summarized in Table 5 and Table 6. The top rows in each table are indexes of the generating models. Recall that models 1 to 5 correspond to dominant regimes and models 6 to 10 correspond to outlier clusters. The second row gives the sizes of each true cluster generated by these models. The following rows then give the composition of each derived clusters, plus the outlier pool in the case of the proposed algorithm.

Our algorithm produced 5 major clusters plus the outlier pool. Each derived major cluster is a close match to one of the true clusters. The outlier pool captured 3 out of the 5 outliers.

In comparison, the Matryoshka algorithm also produced a total of 6 clusters, same as our algorithm when counting the outlier pool. However, one of the clusters (C1) is mixture of two true clusters, while another cluster (C2) is spurious cluster consisting of part of true cluster 2 and 2 o the outliers. The reason that major clusters get mixed in the Matryoshaka algorithm is likely to be that the existence o outliers causes the algorithm to focus some models on outliers. As a result, the peak of the BIC measure is reached before the major clusters are correctly separated. In contrast, in our approach outliers are identified and cast away in the outlier pool, allowing the algorithm to focus more on the major clusters.

TABLE 1
Outline of the clustering algorithm

Assign all sequences to one cluster.
Apply Model Construction to the cluster.
Sample Reassignment/Outlier Detection.
Compute normalized partition BIC measure.
while BIC measure for current partition > BIC measure of previous
partition:

Partition Growing.
Apply Model Construction to each new cluster.
Sample Reassignment/Outlier Detection.
Compute normalized BIC for current partition.

end while
Accept the previous partition as the final partition.

TABLE 2
The Partition Growing Module

Identify the cluster k with lowest average likelihood.
Compute pair-wise distance matrix D using DTW.
Split cluster k into two clusters based on D.

TABLE 3
The Sample Reassignment/Outlier Detection Module

Repeat

Compute the acceptance threshold for each model using

Monte Carlo simulation

For each sequence xi, identify model j with highest

likelihood;

If likelihood > acceptance threshold

then assign xi to cluster j
otherwise assign xi to outlier pool.

Apply Model Construction to each cluster with

changed membership

until no more change of cluster membership

TABLE 4
Performance comparison

| | |
|---|---|
| PMC measure | DCM measure |

| | Matryoshka | Proposed | Matryoshka | Proposed |
|---|---|---|---|---|
| Set 1 | 126 | 16 | 0.478 | 0.083 |
| Set 2 | 122 | 10 | 0.413 | 0.026 |

TABLE 5
Composition of clusters derived by
proposed algorithm on data set 1

| Index | 1 | 2 | 3 | 4 | 5 | 6 | 7 | 8 | 9 | 10 |
|---|---|---|---|---|---|---|---|---|---|---|
| True size | 100 | 60 | 30 | 30 | 10 | 1 | 1 | 1 | 1 | 1 |
| C1 | 1 | 0 | 60 | 0 | 0 | 0 | 0 | 0 | 0 | 0 |
| C2 | 0 | 60 | 0 | 2 | 0 | 1 | 0 | 0 | 0 | 0 |
| C3 | 0 | 0 | 0 | 28 | 0 | 0 | 0 | 0 | 1 | 0 |
| C4 | 96 | 0 | 0 | 0 | 0 | 0 | 0 | 0 | 0 | 0 |
| C5 | 3 | 0 | 0 | 0 | 10 | 0 | 0 | 0 | 0 | 0 |
| Outlier | 0 | 0 | 0 | 0 | 0 | 0 | 1 | 1 | 0 | 1 |

TABLE 6
Composition of clusters derived by the
Matryoshka algorithm on data set 1

| Index | 1 | 2 | 3 | 4 | 5 | 6 | 7 | 8 | 9 | 10 |
|---|---|---|---|---|---|---|---|---|---|---|
| True size | 100 | 60 | 30 | 30 | 10 | 1 | 1 | 1 | 1 | 1 |
| C1 | 0 | 52 | 57 | 0 | 0 | 0 | 0 | 0 | 0 | 0 |
| C2 | 0 | 7 | 0 | 0 | 0 | 1 | 0 | 1 | 0 | 0 |
| C3 | 96 | 1 | 2 | 0 | 0 | 0 | 0 | 0 | 0 | 0 |
| C4 | 0 | 0 | 0 | 30 | 0 | 0 | 3 | 0 | 0 | 0 |
| C5 | 4 | 0 | 1 | 0 | 10 | 0 | 0 | 0 | 0 | 0 |
| C6 | 0 | 0 | 0 | 0 | 0 | 0 | 1 | 0 | 1 | 1 |

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for predicting resource requirements of a service engagement, comprising:
modeling records of past service engagements to create and classify one or more templates of service resource usage; and
generating a service resource plan for said service engagement using a template created by said modeling, wherein characteristics of said service engagement are used to select a created template by its classification and wherein input attributes of said service engagement are used to customize the selected template.

2. A method according to claim 1, wherein said modeling further comprises:
clustering the past service engagements into groups having similar service resource requirements;
creating a staffing template for each clustered group reflecting service resource patterns typical for engagements in the group; and
identifying characteristics of each group by which a service engagement may be classified as belonging to the group.

3. A method according to claim 1, wherein generating a service resource plan further comprises:
inputting identifying characteristics and input attributes of the service engagement;
assigning the service engagement to a clustered group, based on said identifying characteristics; and
adapting the template of the assigned clustered group to fit the input attributes of the service engagement to generate a plan.

4. A method according to claim 2, wherein the clustering is done by computing the dissimilarity between any two past engagements and then applying hierarchical clustering.

5. A method according to claim 2, wherein the clustering is done by computing the dissimilarity between any two past engagements using dynamic time warping.

6. A method according to claim 2, wherein the clustering is done by fitting Hidden Markov Models to the past engagements.

7. A method according to claim 6, wherein dynamic time warping is used to quantify dissimilarity between engagement sequences prior to fitting Hidden Markov Models.

8. A method according to claim 7, wherein a Baysian Information Criterion (BIC) is used to measure goodness of fit of the Hidden Markov Models, the BIC measures being normalized by the length of said engagement sequences.

9. A method according to claim 6, wherein an engagement sequence whose likelihood is below a threshold value is rejected by an HMM model, and wherein an engagement sequence rejected by all current HMM models is not modeled.

10. A system for predicting resource requirements of a service engagement, comprising:
means for modeling records of past service engagements to create and classify one or more templates of service resource usage; and
means for generating a service resource plan for said service engagement using a template created by said modeling, wherein characteristics of said service engagement are used to select a created template by its classification and wherein input attributes of said service engagement are used to customize the selected template.

11. A system according to claim 10, wherein said means for modeling further comprises:
means for clustering the past service engagements into groups having similar service resource requirements;
means for creating a staffing template for each clustered group reflecting service resource patterns typical for engagements in the group; and
means for identifying characteristics of each group by which a service engagement may be classified as belonging to the group.

12. A system according to claim 10, wherein means for generating a service resource plan further comprises:
means for inputting identifying characteristics and input attributes of the service engagement;
means for assigning the service engagement to a clustered group, based on said identifying characteristics; and
means for adapting the template of the assigned clustered group to fit the input attributes of the service engagement to generate a plan.

13. A system according to claim 11, wherein the clustering is done by computing the dissimilarity between any two past engagements and then applying hierarchical clustering.

14. A system according to claim 11, wherein the clustering is done by computing the dissimilarity between any two past engagements using dynamic time warping.

15. A system according to claim 11, wherein the clustering is done by fitting Hidden Markov Models (HMMs) to the past engagements.

16. A system according to claim 15, wherein dynamic time warping is used to quantify dissimilarity between engagement sequences prior to fitting Hidden Markov Models.

17. A system according to claim 16, wherein a Baysian Information Criterion (BIC) is used to measure goodness of fit of the Hidden Markov Models, the BIC measures being normalized by the length of said engagement sequences.

18. A system according to claim 6, wherein an engagement sequence whose likelihood is below a threshold value is rejected by an HMM model, and wherein an engagement sequence rejected by all current HMM models is not modeled.

19. A computer implemented system for predicting resource requirements of a service engagement, comprising:
first computer code for modeling records of past service engagements to create and classify one or more templates of service resource usage; and
second computer code for generating a service resource plan for said service engagement using a template created by said modeling, wherein characteristics of said service engagement are used to select a created template by its classification and wherein input attributes of said service engagement are used to customize the selected template.

20. A computer implemented system according to claim 19, wherein said first computer code for modeling further comprises:
third computer code for clustering the past service engagements into groups having similar service resource requirements;
fourth computer code for creating a staffing template for each clustered group reflecting service resource patterns over time typical for engagements in the group; and
fifth computer code for identifying characteristics of each group by which a service engagement may be classified as belonging to the group.
